(19) United States
(12) Patent Application Publication
(10) Pub. No.: US 2023/0356689 A1
(43) Pub. Date: Nov. 9, 2023

(54) WEBBING TAKE-UP DEVICE

(71) Applicant: KABUSHIKI KAISHA TOKAI-RIKA-DENKI-SEISAKUSHO, Aichi (JP)

(72) Inventors: Hayato UCHIBORI, Aichi (JP); Yoshiteru SAKAGUCHI, Aichi (JP); Yuta SUZUKI, Aichi (JP); Tomoya YOKOI, Aichi (JP)

(21) Appl. No.: 18/025,596

(22) PCT Filed: Jun. 17, 2021
(86) PCT No.: PCT/JP2021/023120

§ 371 Date: Mar. 9, 2023

(30) Foreign Application Priority Data
Sep. 25, 2020 (JP) 2020-161486

(51) Int. Cl. B60R 22/46

(52) U.S. Cl. CPC B60R 22/4633

(57) ABSTRACT

In this webbing take-up device, teeth are formed on flange portions of a rotational member that are disposed opposing each other. The teeth are provided on mutually opposing sides of the flange portions. Discharge portions are formed in the teeth on a rotational center side of the rotational member, and tooth spaces that are adjacent via the teeth are communicated with each other by the discharge portions. Because of the discharge portions, shavings can be discharged, and the shavings can be inhibited from collecting in the tooth spaces.

### TECHNICAL FIELD

The present invention relates to a webbing take-up device where a spool is rotated in a take-up direction as a result of a rotational member being rotated,

### BACKGROUND ART

For example, in the webbing take-up device disclosed in JP-A No. 2014-201154, when a gas generated as a result of a gas generator being activated is supplied to the inside of a cylinder, a rack made of synthetic resin is moved by the pressure of the gas toward the axial direction distal end side of the cylinder. The rack that has been moved from the axial direction distal end of the cylinder to the outside of the cylinder meshes with teeth of a pinion and causes the pinion to rotate in a take-up direction. The pinion is coupled to a spool, and when the pinion is rotated in the take-up direction, the spool is rotated in the take-up direction and a webbing is taken up on the spool.

In this connection, when the rack meshes with the teeth of the pinion, the rack becomes shaved if the pinion does not rotate, and because of this, shavings form. The shavings collect in tooth spaces between the teeth of the pinion that are mutually adjacent in the rotational direction of the pinion.

### SUMMARY OF INVENTION

### Technical Problem

In consideration of the above circumstances, it is an object of the present invention to obtain a webbing take-up device that can inhibit shavings from a moving member from collecting in tooth spaces of a rotational member.

### Solution to Problem

A webbing take-up device of a first aspect of the invention includes: a spool on which a webbing of a seat belt device is taken up as a result of the spool being rotated in a take-up direction; a tubular cylinder whose axial direction distal end side is open; a fluid supply unit that is provided on an axial direction base end side of the cylinder and supplies a fluid to an inside of the cylinder at a time of a vehicle emergency; a rotational member at which, at one of a pair of flange portions that oppose each other and are coaxially rotated, teeth are formed heading toward the other, the rotational member rotating to one side, whereby the spool is rotated in the take-up direction; a moving member that is provided inside the cylinder, is moved toward an axial direction distal end side of the cylinder by pressure of the fluid, and causes the rotational member to rotate to one side as a result of being moved in a state in which the teeth of the rotational member are engaged with the moving member; and discharge portions that are provided on a rotational center side of the rotational member and can discharge shavings that form when the teeth of the rotational member have engaged with the moving member.

In the webbing take-up device of the first aspect of the invention, the fluid supply unit is provided on the axial direction base end side of the cylinder, and when the fluid supply unit is activated at the time of a vehicle emergency, the fluid is supplied to the inside of the cylinder. When the internal pressure in the cylinder is raised because of this, the moving member provided inside the cylinder is moved toward the axial direction distal end side of the cylinder. When the moving member is moved toward the axial direction distal end side of the cylinder and the moving member comes out from the opening in the axial direction distal end side of the cylinder, the moving member engages with the teeth of the rotational member. Because of this, the rotational member is rotated to one side. When the rotational member is rotated to one side, the spool is rotated in the take-up direction, and because of this the webbing of the seat belt device is taken up on the spool.

Meanwhile, if the rotational member does not rotate when the moving member has engaged with the teeth of the rotational member, because of this the moving member is shaved and shavings are formed. The shavings are discharged from the discharge portions provided on the rotational center side of the rotational member. Because of this, the shavings can be inhibited from collecting in tooth spaces between the teeth that are mutually adjacent in the rotational direction of the rotational member.

A webbing take-up device of a second aspect of the invention is the webbing take-up device of the first aspect of the invention, the webbing take-up device of claim 1, wherein the teeth are disposed on a medial side between the pair of flange portions further toward the rotational center side in the pair of flange portions than toward an opposite side from the rotational center in the pair of flange portions.

in the webbing take-up device of the second aspect of the invention, the teeth formed on the flange portions of the rotational member are disposed on the medial side between the pair of flange portions more toward the rotational center side in the pair of flange portions than the opposite side of the rotational center in the pair of flange portions. For this reason, the moving member engages a large extent with the teeth of the rotational member.

A webbing take-up device of a third aspect of the invention is the webbing take-up device of the second aspect of the invention, wherein a cross-sectional shape of the moving member cut in a direction orthogonal to an axial direction of the moving member is circular, and the teeth are curved with a center of curvature on an outer side in a radial direction of rotation of the pair of flange portions.

In the webbing take-up device of the third aspect of the invention, the cross-sectional shape of the moving member cut in a direction orthogonal to the axial direction of the moving member is circular. Furthermore, the teeth formed on the flange portions of the rotational member are curved with a center of curvature on the outer side in the radial direction of rotation of the pair of flange portions. For this reason, of the cross-sectional shape of the moving member cut in a direction orthogonal to the axial direction of the moving member, most on the center side of the flange portions of the rotational member engages with the teeth of the rotational member.

A webbing take-up device of a fourth aspect of the invention is the webbing take-up device of any one of the first aspect to the third aspect of the invention, wherein the discharge portions are provided at a medial side in a radial direction of rotation of the rotational member between teeth formed heading from one of the flange portions toward the other of the flange portions and teeth formed heading from the other of the flange portions toward the one of the flange portions.

A webbing take-up device of a fifth aspect of the invention is the webbing take-up device of the fourth aspect of the invention, wherein a distance, in an axial direction of rotation of the rotational member, between the teeth formed heading from the one of the flange portions toward the other of the flange portions and the teeth formed heading from the other of the flange portions toward the one of the flange portions becomes narrower toward the medial side in the radial direction of rotation of the rotational member.

A webbing take-up device of a sixth aspect of the invention is the webbing take-up device of the fourth aspect of the invention, wherein a distance, in an axial direction of rotation of the rotational member, between the teeth formed heading from the one of the flange portions toward the other of the -flange portions and the teeth formed heading from the other of the flange portions toward the one of the flange portions is the same at each position in the radial direction of rotation of the rotational member.

### Advantageous Effects of Invention

As described above, the webbing take-up device pertaining to the present invention can inhibit shavings from the moving member from collecting in the tooth spaces of the rotational member.

### BRIEF DESCRIPTION OF DRAWINGS

FIG. 1 is an exploded perspective view of a webbing take-up device pertaining to a first embodiment.

FIG. 2 is a sectional view cut in a direction orthogonal to a vehicle front and rear direction.

FIG. 3 is a side view, looking inside a cover plate from a vehicle front direction, showing a state in which a moving member has come into abutment with a stopper.

FIG. 4 is a sectional view, corresponding to FIG. 2, showing a second embodiment.

FIG. 5 is a sectional view, corresponding to FIG. 3, showing the second embodiment.

### DESCRIPTION OF EMBODIMENTS

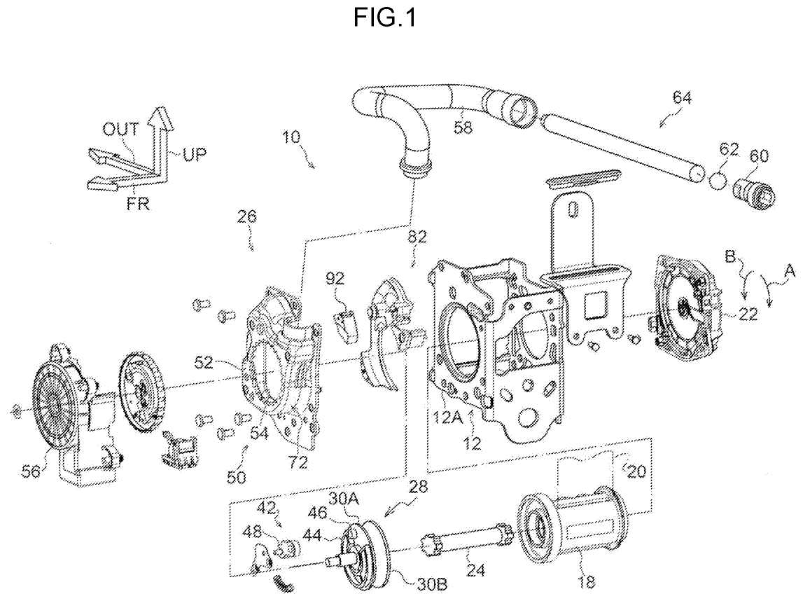

Next, embodiments of the invention will be described based on the drawings from FIG. 1 to FIG. 5. It will be noted that, in the drawings, arrow FR indicates a forward direction of a vehicle to which a webbing take-up device 10 is applied, arrow OUT indicates an outward direction in a vehicle width direction, and arrow UP indicates a vehicle upward direction. Furthermore, in the drawings, arrow A indicates a take-up direction, which is a. rotational direction of a spool 18 when the spool 18 takes up a webbing 20, and arrow B indicates a pull-out direction opposite the take-up direction,

<Configuration of First Embodiment>

As shown in FIG. 1, the webbing take-up device 10 pertaining to the present embodiment includes a frame 12. The frame 12 is secured to a vehicle lower portion of a center pillar (not shown in the drawings) serving as a vehicle body of the vehicle.

Furthermore, in the frame 12 is provided a spool 18. The spool 18 is formed in a substantially cylindrical shape and is rotatable about a center axis (the direction of arrow A and the direction of arrow Bin FIG. 1). Anchored to the spool 18 is a lengthwise direction base end portion of a long band-like webbing 20, and when the spool 18 is rotated in the take-up direction (the direction of arrow A in FIG. I), the webbing 20 is taken up from its lengthwise direction base end side on the spool 18. Furthermore, a lengthwise direction distal end side of the webbing 20 extends in the vehicle upward direction from the spool 18, passes through a slit hole formed in a through anchor (not shown in the drawings) supported on the center pillar on the vehicle upper side of the frame 12, and is looped back in the vehicle downward direction.

Moreover, the lengthwise direction distal end portion of the webbing 20 is anchored to an anchor plate (not shown in the drawings). The anchor plate is formed of a metal plate material such as iron and is secured, for example, to a floor (not shown in the drawings) of the vehicle or a skeletal member of a seat (not shown in the drawings) corresponding to the webbing take-up device 10.

Furthermore, a seat belt device for a vehicle to Which the webbing take-up device 10 is applied includes a buckle device (not shown in the drawings). The buckle device is provided on the vehicle width direction inner side of the seat (not shown in the drawings) to which the webbing take-up device 10 is applied. When a tongue (not shown in the drawings) provided on the webbing 20 is engaged to the buckle device in a state in which the webbing 20 has been pulled across the body of an occupant sitting in the seat, the webbing 20 is secured on the body of the occupant.

Furthermore, as shown in FIG. 1, on the vehicle rear side of the frame 12 is provided a spring housing 22. Inside the spring housing 22 is provided a spool energizing member (not shown in the drawings) such as a flat spiral spring. The spool energizing member is directly or indirectly engaged with the spool 18, and the spool 18 is energized in the take-up direction (the direction of arrow A in FIG. 1) by energizing force of the spool energizing member.

Moreover, the webbing take-up device 10 includes a torsion bar 24 that configures a. force limiter mechanism. The vehicle rear portion of the torsion bar 24 is disposed inside the spool 18 and is connected to the spool 18 in a state in which relative rotation with respect to the spool 18 is limited. In contrast, the vehicle front portion of the torsion bar 24 passes through a hole formed in the frame 12 and extends to the outside (the vehicle front side) of the frame 12.

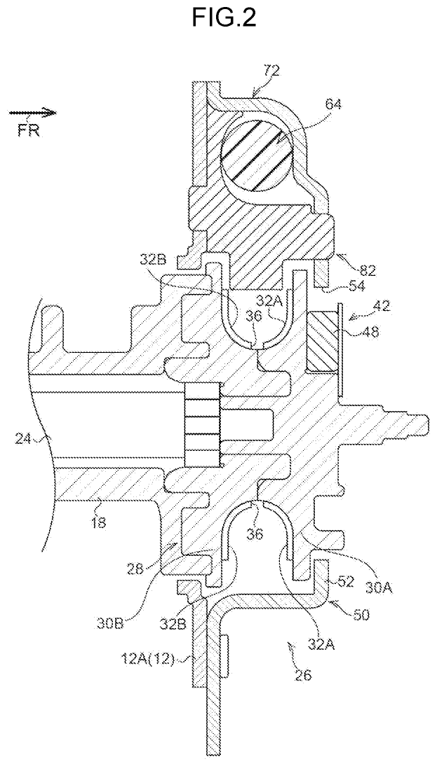

On the vehicle front side of the frame 12 is provided a rotational member 28 of a pretensioner 26. The rotational member 28 is disposed coaxially with respect to the spool 18, The vehicle front portion of the torsion bar 24 is coupled to the rotational member 28, and relative rotation of the rotational member 28 with respect to the vehicle front portion of the torsion bar 24 is limited. Furthermore, the rotational member 28 includes a pair of flange portions 30A, 30B that oppose each other in the vehicle front and rear direction. As shown in FIG. 2, on the flange portion 30A relatively disposed on the vehicle front side among the pair of flange portions 30A, 30B, plural teeth 32A are provided.

These teeth 32A are provided on the surface of the flange portion 30A on the flange portion 30B side. These teeth 32A are disposed on the medial side between the pair of flange portions 30A, 30B more toward the rotational center side in the pair of flange portions 30A, 30B than the opposite side of the rotational center in the pair of flange portions 30A, 30B. Furthermore, these teeth 32A are radially disposed at a predetermined angle about the rotational center of the flange portion 30A. Moreover, the lengthwise direction of the teeth 32A is along the radial direction of rotation of the flange portion 30A. Furthermore, the projecting dimension of these teeth 32A from the flange portion 30A is small on the outer side in the radial direction of rotation of the flange portion 30A and large on the medial side in the radial direction of rotation of the flange portion 30A. It will be noted that the projecting dimension of the teeth 32A from the flange portion 30A is the dimension from the flange portion 30A to the tips of the teeth 32A in the axial direction of rotation of the flange 30A.

In particular, at the medial side in the radial direction of rotation of the flange portion 30A, the teeth 32A are curved with a center of curvature more toward the outer side in the radial direction of rotation of the flange portion 30A than a formation position of the teeth 32A. In the present embodiment, the radius of curvature of the teeth 32A on the medial side in the radial direction of rotation of the flange portion 30A is smaller than the radial dimension of the cross-sectional shape of a later-described moving member 64 cut in a direction orthogonal to the axial direction of the moving member 64.

Meanwhile, on the flange portion 30B, plural teeth 32B are provided. These teeth 32B are provided on the surface of the flange portion 30B on the flange portion 30A side. These teeth 32B are disposed on the medial side between the pair of flange portions 30A, 30B more toward the rotational center side in the pair of flange portions 30A, 30B than the opposite side of the rotational center in the pair of flange portions 30A, 30B. Furthermore, these teeth 32B are radially disposed at a predetermined angle about the rotational center of the flange portion 30B. Moreover, the lengthwise direction of the teeth 32B is along the radial direction of rotation of the flange portion 30B. Furthermore, the projecting dimension of these teeth 32B from the flange portion 30B is small on the outer side in the radial direction of rotation of the flange portion 30B and large on the medial side in the radial direction of rotation of the flange portion 30B. It will be noted that the projecting dimension of the teeth 32B from the flange portion 30B is the dimension from the flange portion 30B to the tips of the teeth 32B in the axial direction of rotation of the flange 30B.

In particular, at the medial side in the radial direction of rotation of the flange portion 30B, the teeth 32B are curved with a center of curvature more toward the outer side in the radial direction of rotation of the flange portion 30B than a formation position of the teeth 32B. In the present embodiment, the radius of curvature of the teeth 32B on the medial side in the radial direction of rotation of the flange portion 30B is smaller than the radial dimension of the cross-sectional shape of the later-described moving member 64 cut in a direction orthogonal to the axial direction of the moving member 64. The number of the teeth 32B is the same as the number of the teeth 32A, and the teeth 32A and the teeth 32B oppose each other in the opposing direction of the flange portion 30A and the flange portion 30B. Furthermore, the distance between the teeth 32A and the teeth 32B in the axial direction of rotation of the rotational member 28 becomes narrower toward the medial side in the radial direction of rotation of the rotational member 28.

Between the teeth 32A and the teeth 32B, discharge portions 36 are provided. The discharge portions 36 are provided on the medial side in the radial direction of rotation of the rotational member 28, and tooth spaces on the take-up direction side and tooth spaces on the pull-out direction side are interconnected via the discharge portions 36. It will be noted that the tooth spaces are spaces between the teeth 32A, 32B that are adjacent in the circumferential direction of rotation of the rotational member 28.

Furthermore, the flange portion 30A serves as a lock base 44 of a lock mechanism 42. The lock base 44 includes a lock pawl 48. The lock pawl 48 is supported by a boss 46 formed on the lock base 44 and is swingable about the boss 46.

Meanwhile, secured to a leg plate 12A on the vehicle front side of the frame 12 is a. cover plate 50 that configures both the lock mechanism 42 and the pretensioner 26. The cover plate 50 opens in the vehicle rearward direction, and a bottom plate 52 of the cover plate 50 opposes the frame 12 in a stale in which it is spaced apart in the vehicle forward direction from the frame 12. In the bottom plate 52 is formed a ratchet hole 54. On the inner peripheral portion of the ratchet hole 54 are formed ratchet teeth, and when the lock pawl 48 of the lock base 44 is swung in one direction about the boss 46, the distal end portion of the lock pawl 48 meshes with the ratchet teeth of the ratchet hole 54. Because of this, rotation of the lock base 44 in the pull-out direction (the direction of arrow B in FIG. 1) is limited, and rotation of the spool 18 in the pull-out direction is indirectly limited.

Furthermore, on the vehicle front side of the cover plate 50 is provided a sensor holder 56 of the lock mechanism 42. The sensor holder 56 opens in the vehicle rearward direction and is secured to the frame 12 directly or indirectly via the cover plate 50. Inside the sensor holder 56 are housed parts configuring a sensor mechanism that detects an emergency state of the vehicle, and when the sensor mechanism inside the sensor holder 56 is activated at the time of a vehicle emergency, the lock pawl 48 of the lock base 44 is swung in one direction about the boss 46 in conjunction with the rotation of the lock base 44 of the lock mechanism 42 in the pull-out direction.

Meanwhile, the webbing take-up device 10 includes a cylinder 58 serving as a tubular member that configures the pretensioner 26. The cylinder 58 is formed in a cylindrical shape and is appropriately bent in its axial direction middle portion. A micro gas generator 60 (hereinafter “micro gas generator 60” will be abbreviated as and called “MGG 60”) serving as a fluid supply unit inserted into the axial direction base end side of the cylinder 58 is electrically connected to an impact detection sensor provided in the vehicle via an ECU serving as a control unit (neither of which is shown in the drawings), and when a shock at the time of a vehicle impact is detected by the impact detection sensor, the MGG 60 is activated by the ECU, so that a gas which is one aspect of a fluid generated in the MGG 60, is supplied to the inside of the cylinder 58.

Inside the axial direction base end side of the cylinder 58 of the pretensioner 26 is disposed a sealing ball 62 serving as a piston. The sealing ball 62 is formed of a synthetic resin material, and the shape of the sealing ball 62 in a state in which a load is not acting on the sealing ball 62 is substantially spherical. The inside space of the cylinder 58 is partitioned by the sealing ball 62 into an axial direction base end side of the sealing ball 62 and an axial direction distal end side of the sealing ball 62. When the MGG 60 is activated, the gas generated by the MGG 60 is supplied to the space in the cylinder 58 between the MGG 60 and the sealing ball 62. Because of this, when the internal pressure is raised in the space in the cylinder 58 between the MGG 60 and the sealing ball 62, the sealing ball 62 is moved toward the axial direction distal end side of the cylinder 58 and becomes compressed and deformed in the axial direction of the cylinder 58.

Furthermore, inside the cylinder 58 of the pretensioner 26 is disposed a moving member 64, and the lengthwise direction base end portion of the moving member 64 is disposed inside the cylinder 58. The moving member 64 is formed of a synthetic resin material and is deformable upon being subjected to an external force. The moving member 64 is disposed on the cylinder 58 axial direction distal end side of the sealing ball 62, and when the sealing ball 62 is moved toward the axial direction distal end side of the cylinder 58, the moving member 64 is pushed by the sealing ball 62 and moved toward the axial direction distal end side of the cylinder 58.

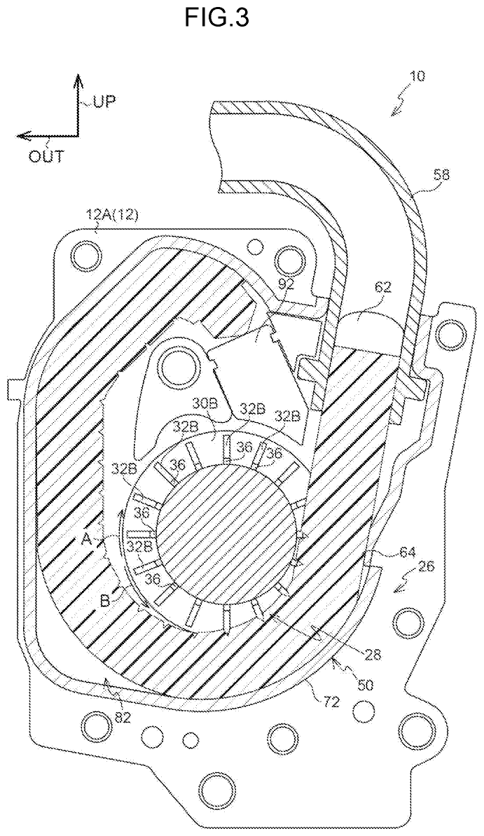

When the moving member 64 is further pushed by the sealing ball 62 and moved in a state in which the moving member 64 has reached the axial direction distal end of the cylinder 58, the moving member 64 comes out from the axial direction distal end of the cylinder 58 in the vehicle downward direction and enters the inside of the cover plate 50. When the moving member 64 is further moved in the vehicle downward direction in this state, as shown in FIG. 3, the lengthwise direction distal end portion of the moving member 64 comes into abutment with the teeth 32A, 32B of the rotational member 28. In this state, the teeth 32A, 32B are pushed in the vehicle downward direction by the moving member 64, whereby rotational force in the take-up direction from the moving member 64 is applied to the rotational member 28. Because of this, the rotational member 28 is rotated in the take-up direction, and the moving member 64 is further moved in the vehicle downward direction by the pressure from the sealing ball 62.

In this way, the moving member 64 is moved in the vehicle downward direction and the rotational member 28 is rotated in the take-up direction, whereby the teeth 32A, 32B of the rotational member 28 stab the moving member 64, in this state the moving member 64 is further moved in the vehicle downward direction, whereby rotational force in the take-up direction is further applied to the rotational member 28, and the rotational member 28 is further rotated in the take-up direction.

Meanwhile, as shown in FIG. 1 and FIG. 2, the cover plate 50 includes the bottom plate 52. The bottom plate 52 is platelike, and the thickness direction of the bottom plate 52 generally coincides with the vehicle front and rear direction (the direction of arrow FR and the opposite direction in FIG. 1 and FIG. 2). Furthermore, the cover plate 50 includes a side wall 72. The side wall 72 is provided along the outer peripheral portion of the bottom plate 52 of the cover plate 50, and as shown in FIG. 2 and FIG. 3, the rotational member 28 is disposed inside the side -wall 72. Furthermore, as shown in FIG. 3, inside the cover plate 50 is provided a guide member 82. The moving member 64 that has gone down in the vehicle downward direction beyond the rotational member 28 is guided by the side wall 72 of the cover plate 50 and the guide member 82 and rises along the vehicle width direction outer side of the rotational member 28.

On the vehicle upper side of the rotational member 28 is disposed a stopper 92. The moving member 64 that has risen along the vehicle width direction outer side of the rotational member 28 pushes the stopper 92 from the vehicle upper side and the vehicle width direction outer side of the stopper 92. The stopper 92 pushed by the moving member 64 is moved in the vehicle downward direction and inward in the vehicle width direction and engages with the lengthwise direction base end side of the moving member 64. Because of this, the advance of the moving member 64 stops.

### Action and Effects of First Embodiment

Next, the action and effects of the present embodiment will be described.

In the webbing take-up device 10, when the MGG 60 of the pretensioner 26 is activated by the ECU at the time of a vehicle impact, which is one aspect of at the time of a vehicle emergency, the high-pressure gas is instantaneously supplied from the MGG 60 to the inside of the cylinder 58. When the sealing ball 62 is moved by the pressure of the gas toward the axial direction distal end side of the cylinder 58, the moving member 64 is pushed by the sealing ball 62 so that the moving member 64 is moved toward the axial direction distal end side of the cylinder 58.

Because the moving member 64 is moved toward the axial direction distal end side, the moving member 64 comes out from the axial direction distal end of the cylinder 58 in the vehicle downward direction, and the moving member 64 comes into abutment with the teeth 32A, 32B of the rotational member 28. Because of this, the teeth 32A, 32B of the rotational member 28 are pushed in the vehicle downward direction by the moving member 64, whereby rotational force in the take-up direction (the direction of arrow A in FIG. 3) from the moving member 64 is applied to the rotational member 28. Because of this, the rotational member 28 is rotated in the take-up direction.

Moreover, of the plural teeth 32A, 32B of the rotational member 28, the teeth 32A, 32B on the pull-out direction side (on the side in the direction of arrow B in FIG. 2) of the teeth 32A, 32B pushed by the moving member 64 eat into or stab (engage with) the outer peripheral surface of the moving member 64 toward the radial direction medial side of the moving member 64 due to the rotation of the rotational member 28 in the take-up direction.

In this way, the moving member 64 that the teeth 32A, 32B have eaten into or stabbed is moved in the vehicle downward direction, whereby rotational force in the take-up direction is further applied to the rotational member 28, and as for the rotational member 28, the rotational member 28 is further rotated in the take-up direction. The rotation of the rotational member 28 in the take-up direction is transmitted via the torsion bar 24 to the spool 18, and the spool 18 is rotated in the take-up direction. Because of this, the webbing 20 is taken up on the spool 18, and the force with which the occupant is restrained by the webbing 20 is increased.

Meanwhile, when the moving member 64 is moved in the vehicle downward direction beyond the rotational member 28 as a result of the moving member 64 being pushed by the sealing ball 62, the moving member 64 is guided by the side wall 72 of the cover plate 50 and the guide member 82 and is moved in the vehicle upward direction. In this state, when the moving member 64 is further pushed by the sealing ball 62, the axial direction distal end of the moving member 64 becomes positioned on the vehicle upper side and the vehicle width direction outer side of the stopper 92. When the moving member 64 is further pushed by the sealing ball 62 from this state, the moving member 64 pushes the stopper 92 from the vehicle upper side and the vehicle width direction outer side. Because of this, the stopper 92 is moved in the vehicle downward direction and inward in the vehicle width direction and engages with the portion of the moving member 64 on the axial direction base end side of the portion engaged with the rotational member 28. Because of this, the moving member 64 can be prevented from entirely coming out from the cylinder 58, and the sealing ball 62 can be prevented from coming out from the cylinder 58.

In this connection, in a state before the pretensioner 26 is activated, in a case where, for example, the body of the occupant on which the webbing 20 is secured moves in the vehicle forward direction due to acceleration (deceleration) at the time of a sudden deceleration of the vehicle, a load in the pull-out direction is applied to the webbing 20. When a load in the pull-out direction is applied to the webbing 20 in this way, the rotational member 28 is rotated in the pull-out direction. At this time, when the axial direction distal end side of the moving member 64 comes out from the cylinder 58 and the moving member 64 is eaten into or stabbed by the teeth 32A, 32B of the rotational member 28, the rotation of the rotational member 28 in the pull-out direction is stopped, and next the rotational member 28 is rotated in the take-up direction opposite the pull-out direction.

If the rotational member 28 does not rotate when the moving member 64 has been eaten into or stabbed by the teeth 32A, 32B of the rotational member 28 in this -way, some of the moving member 64 is peeled off, becomes shavings, and remains in the tooth spaces between the teeth 32A, 32B that are adjacent in the circumferential direction of the rotational member 28. Here, in the present embodiment, the discharge portions 36 are provided between the teeth 32A, 32B, and the tooth spaces between the teeth 32A, 32B that are adjacent in the circumferential direction of the rotational member 28 are connected to each other. The shavings pass through the discharge portions 36 and move to the tooth spaces between the adjacent teeth 32A, 32B. Because of this, the shavings can be inhibited from collecting in the tooth spaces between the teeth 32A, 32B that are adjacent in the circumferential direction of the rotational member 28.

In this way, because the shavings can be inhibited from collecting in the tooth spaces between the teeth 32A. 32B that are adjacent in the circumferential direction of the rotational member 28, the quantity of the eating or the quantity of the stabbing of the teeth 32A, 32B of the rotational member 28 into the moving member 64 can be ensured. Furthermore, because of this, the teeth 32A, 32B of the rotational member 28 can be inhibited from moving without eating into or stabbing the moving member 64.

Furthermore, the teeth 32A, 32B are disposed on the medial side between the pair of flange portions 30A, 30B more toward the rotational center side in the pair of flange portions 30A, 30B than the opposite side of the rotational center in the pair of flange portions 30A, 30B. Because of this, the moving member 64 engages a large extent with the teeth of the rotational member 28.

Moreover, the radius of curvature of the teeth 32A, 32B on the medial side in the radial direction of rotation of the flange portions 30A, 30B is smaller than the radial dimension of the cross-sectional shape of the moving member 64 cut in a direction orthogonal to the axial direction of the moving member 64. For this reason, although the biting of the teeth 32A, 32B into the moving member 64 is shallow, the teeth 32A, 32B bite into about half the outer peripheral portion of the moving member 64. For this reason, the bending stress of the teeth 32A, 32B when the teeth 32A, 32B have eaten into or stabbed the moving member 64 can be dispersed.

### Second Embodiment

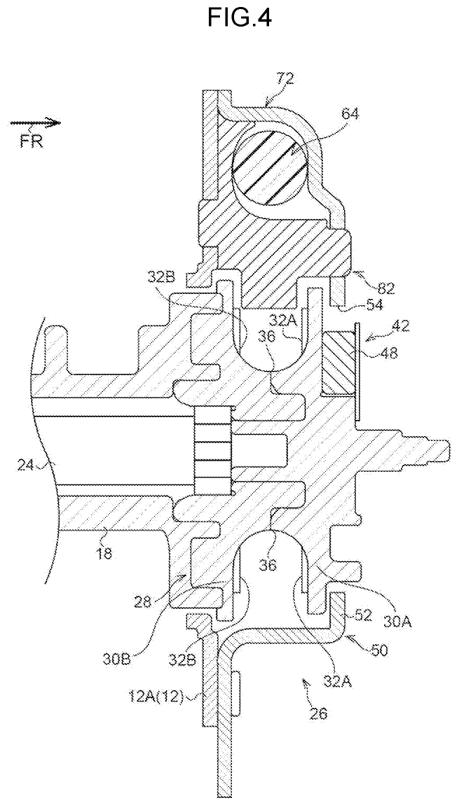

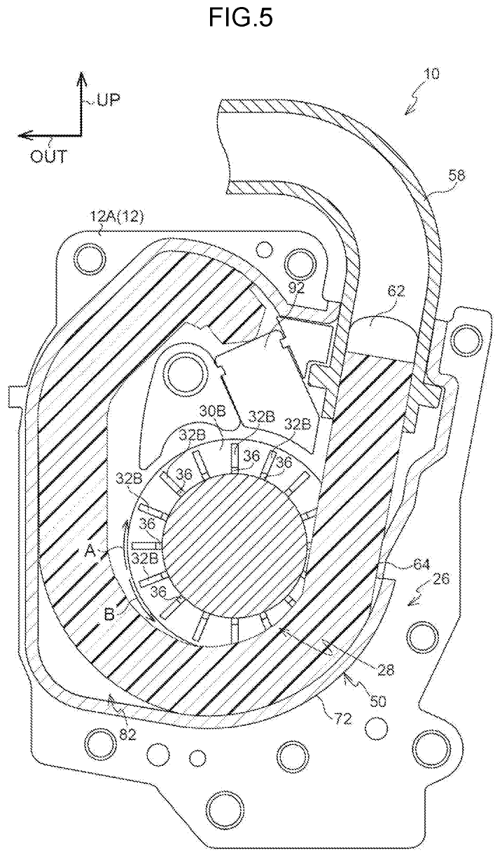

As shown in FIG. 4 and FIG. 5, in the present embodiment, the positions (positions in the axial direction of rotation of the rotational member 28) of the end portions of the teeth 32A on the opposite side of the flange portion 30A side are equal on the medial side in the radial direction of the flange portion 30A and on the outer side in the radial direction of the flange portion 30A. Furthermore, the positions (positions in the axial direction of rotation of the rotational member 28) of the end portions of the teeth 32B on the opposite side of the flange portion 30B side are equal on the medial side in the radial direction of the flange portion 30B and on the outer side in the radial direction of the flange portion 30B. For this reason, the tooth spaces that are adjacent via the teeth 32A, 32B communicate with each other, and these communicated portions are the discharge portions 36. Furthermore, the distance between the teeth 32A and the teeth 32B in the axial direction of rotation of the rotational member 28 is the same at each position in the radial direction of rotation of the rotational member 28.

In the present embodiment also, basically the same effects as the first embodiment can be obtained.

Furthermore, when the lock pawl 48 of the lock base 44 is swung in one direction about the boss 46 and the distal end portion of the lock pawl 48 meshes with the ratchet teeth of the ratchet hole 54 so that rotation of the spool 18 in the pull-out direction is locked, the center axis of the lock base 44 shifts in a direction intersecting the center axis direction of the lock base 44. The center axis of the lock base 44 is the center axis of the flange portion 30A, so the center axis of the rotational member 28 shifts in a direction intersecting the center axis of the rotational member 28.

Here, in the present embodiment, the teeth 32A are formed on the surface of the flange portion 30A on the flange portion 30B side, and the teeth 32B are formed on the surface of the flange portion 30B on the flange portion 30A side. For this reason, even if the rotational member 28 shifts in a direction intersecting the center axis of the rotational member 28, effects on the eating or stabbing of the teeth 32A, 32B into the moving member 64 can be inhibited.

The disclosure of Japanese Patent Application No. 2020-161486 filed on Sep. 25, 2020, is incorporated in its entirety herein by reference.

1. A webbing take-up device comprising:
a spool on which a webbing of a seat belt device is taken up as a result of the spool being rotated in a take-up direction;
a tubular cylinder whose axial direction distal end side is open;
a fluid supply unit that is provided on an axial direction base end side of the cylinder and supplies a fluid to an inside of the cylinder at a time of a vehicle emergency;
a rotational member at which, at one of a pair of flange portions that oppose each other and are coaxially rotated, teeth are formed heading toward another of the pair of flange portions, the rotational member rotating to one side, whereby the spool is rotated in the take-up direction;
a moving member that is provided inside the cylinder, is moved toward an axial direction distal end side of the cylinder by pressure of the fluid, and causes the rotational member to rotate to one side as a result of being moved in a state in which the teeth of the rotational member are engaged with the moving member; and
discharge portions that are provided on a rotational center side of the rotational member and can discharge shavings that form when the teeth of the rotational member have engaged with the moving member.

2. The webbing take-up device of claim 1, wherein the teeth are disposed on a medial side between the pair of flange portions further toward the rotational center side in the pair of flange portions than toward an opposite side from the rotational center in the pair of flange portions.

3. The webbing take-up device of claim 2, wherein a cross-sectional shape of the moving member cut in a direction orthogonal to an axial direction of the moving member is circular, and the teeth are curved with a center of curvature on an outer side in a radial direction of rotation of the pair of flange portions.

4. The webbing take-up device of claim 1, wherein the discharge portions are provided at a medial side in a radial direction of rotation of the rotational member between teeth formed heading from one of the flange portions toward the other of the flange portions and teeth formed heading from the other of the flange portions toward the one of the flange portions.

5. The webbing take-up device of claim 4, wherein a distance, in an axial direction of rotation of the rotational member, between the teeth formed heading from the one of the flange portions toward the other of the flange portions and the teeth formed heading from the other of the flange portions toward the one of the flange portions becomes narrower toward the medial side in the radial direction of rotation of the rotational member.

6. The webbing take-up device of claim 4, wherein a distance, in an axial direction of rotation of the rotational member, between the teeth formed heading from the one of the flange portions toward the other of the flange portions and the teeth formed heading from the other of the flange portions toward the one of the flange portions is the same at each position in the radial direction of rotation of the rotational member.
